(19) United States
(12) Patent Application Publication
(10) Pub. No.: US 2026/0291849 A1
(43) Pub. Date: Sep. 24, 2026

(54) SELF-SERVICE BORDER GATEWAY PROTOCOL (BGP) INSTANTIATION

(71) Applicant: Level 3 Communications, LLC, Denver, CO (US)

(72) Inventors: Lon Breslow, Denver, CO (US); Bryan Dreyer, Bellevue, WA (US); Charles Wiechman, Denver, CO (US); Stephen Powell, Brighton, MI (US)

(73) Assignee: Level 3 Communications, LLC, Denver, CO (US)

(21) Appl. No.: 19/576,289

(22) Filed: Mar. 24, 2026

Related U.S. Application Data
(60) Provisional application No. 63/776,740, filed on Mar. 24, 2025.

(51) Int. Cl. H04L 45/02; H04L 12/46

(52) U.S. Cl. CPC H04L 45/04; H04L 12/46

(57) ABSTRACT

Novel tools and techniques are provided for implementing self-service border gateway protocol ("BGP") instantiation. In examples, a computing system may receive, via a user interface ("UI"), a user input to order a network service, the user input including a physical address of a building in which network service is to be provided. The computing system may exchange BGP information with a gateway device located at a customer premises associated with the physical address, and may autonomously identify a set of network routes between the gateway device and a network node that connects to service provider networks. The computing system may autonomously generate a BGP session based on the set of network routes and on the BGP information, may autonomously establish a network connection between the gateway device and the network node based on the BGP session, and may provision the network service over the network connection.

### CROSS-REFERENCE TO RELATED APPLICATIONS

This application claims the benefit of U.S. Provisional Application No. 63/776,740 filed Mar. 24, 2025, entitled “Self-Service Border Gateway Protocol (BGP) Instantiation,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing provisioning of network services, and, more particularly, to methods, systems, and apparatuses for implementing self-service border gateway protocol ("BGP") instantiation.

### BACKGROUND

BGP is a protocol that is used for routing either within an autonomous system ("AS") or among ASs, by enabling exchange of routing and reachability information and generating routing decisions based on paths, network policies, or rules for the network(s). Using BGP to route between two network nodes (whether in the same AS or in different ASs) first requires configuration of the two network nodes to establish the two network nodes as BGP neighbors or peers. A BGP session may be established between BGP neighbors to enable BGP connectivity for routing data traffic. BGP connectivity is typically handled by service providers or cloud providers within their networks, rather than providing end-user configuration nor provisioning BGP connectivity to particular buildings or customer premises. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing self-service BGP instantiation, in accordance with various embodiments.

FIG. 2 depicts an example system illustrating communication exchange between a computing system(s) and gateway devices at customer premises when implementing self-service BGP instantiation, in accordance with various embodiments.

FIG. 3 depicts a flow diagram illustrating a method for implementing self-service BGP instantiation, in accordance with various embodiments.

FIG. 4 depicts a flow diagram illustrating another method for implementing self-service BGP instantiation, in accordance with various embodiments.

FIG. 5 depicts a flow diagram illustrating yet another method for implementing self-service BGP instantiation, in accordance with various embodiments.

FIG. 6 depicts a block diagram illustrating an exemplary computer or system hardware architecture, in accordance with various embodiments.

### DETAILED DESCRIPTION OF CERTAIN EMBODIMENTS

### Overview

In examples, a computing system may receive a user input to order a network service, via a user interface ("UI"). The user input may include a physical address of a building (or each of multiple buildings) in which network service is to be provided by a service provider. The computing system may exchange BGP information with a gateway device located at a customer premises associated with the physical address (or at each customer premises associated with a corresponding one of the physical addresses), and may autonomously identify (for each gateway device) a set of network routes between that gateway device and a network node that connects to networks of the service provider, in some cases, by analyzing available network routes between that gateway device and the network node. For each gateway device, the computing system may autonomously generate a BGP session based on the set of network routes and based on the BGP information exchanged between the computing system and the gateway device, and may autonomously establish a network connection between the gateway device and the network node based on the BGP session. The network service may be provisioned over the network connection.

In some examples, the user input may further include a user input to select one or more user-network interface ("UNI") ports over which to establish a BGP session/connection, a user input to select a network service template among a plurality of network service templates, a user input to select a service configuration template from among a plurality of service configuration templates, and/or a user input to end or terminate a network service (e.g., among one or more network services), and/or the like. In the case that the user input includes a selection of a UNI port for each physical address, each customer premises, and/or each building, the set of network routes that may be identified may include routing through the selected UNI port and over a corresponding connection line (e.g., one of 100 megabits per second (Mbps) ("100M"), 1 gigabits per second (Gbps) ("1G"), 10 Gbps ("10G"), 100 Gbps ("100G") communication lines, or the like). In the case that the user input includes selection of a network service template among a plurality of network service templates, the network service may be provisioned based on the selected network service template. In the case that the user input includes selection of a service configuration template from among a plurality of service configuration templates, the network service may be configured based on the selected service configuration template.

These and other aspects of the self-service BGP instantiation are described in greater detail with respect to the figures. In the manner above, the system, via the UI, enables an end-user to provision and terminate network services over BGP sessions, in a self-service manner (i.e., initiated by the end-user, with system automation causing instantiation of the BGP connectivity and BGP-based network services), via network-to-network interfaces ("NNIs") and UNIs, rather than the service provider having to set up provisioning and termination at data centers. Different from conventional systems and implementations in which BGP connectivity is either in cloud networks or at the data center level, the present technology provides full BGP-based connectivity from cloud networks and/or data center networks down to user/customer networks at the customer premises level (at particular buildings, as specified by physical addresses in the user input/order). The present technology also enables BGP settings and configurations on-demand, via the UI (as described in detail below).

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes "a" through "n" may be used, where n denotes any suitable non-negative integer number (unless it denotes the number 14, if there are components with reference numerals having suffixes "a" through "m" preceding the component with the reference numeral having a suffix "n"), and may be either the same or different from the suffix "n" for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term "about." In this application, the use of the singular includes the plural unless specifically stated otherwise, and use of the terms "and" and "or" means "and/or" unless otherwise indicated. Moreover, the use of the term "including," as well as other forms, such as "includes" and "included," should be considered non-exclusive. Also, terms such as "element" or "component" encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase "at least one of element A, element B, or element C" (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a computing system and via a UI, a first user input to order a network service, wherein the first user input includes a physical address of a building in which network service is to be provided by a service provider; exchanging, by the computing system, BGP information with a gateway device located at a customer premises associated with the physical address; autonomously identifying, by the computing system, a first set of network routes between the gateway device and a network node that connects to networks of the service provider, by analyzing available network routes between the gateway device and the network node; autonomously generating, by the computing system, a BGP session based on the first set of network routes and based on the BGP information exchanged between the computing system and the gateway device; and autonomously establishing, by the computing system, a network connection between the gateway device and the network node based on the BGP session.

In another aspect, the technology relates to a method, including receiving, by a computing system and via a UI, a first user input to order a network service, wherein the first user input includes a physical address of each of one or more buildings in which network service is to be provided by a service provider, wherein the first user input further includes a selection of one or more types of network services; receiving, by the computing system and via the UI, a second user input to select one or more UNI ports for each of at least one customer premises each corresponding to one of the one or more buildings; autonomously establishing, by the computing system, a network connection between a gateway device located at a customer premises associated with the physical address and a network node that connects to networks of the service provider, via the one or more UNI ports, based on autonomous configurations that include an exchange of BGP information between the computing system and the gateway device that is used to establish a BGP session; and autonomously provisioning, by the computing system, one or more network services over the network connection, via the one or more UNI ports, the one or more network services corresponding to the selection of the one or more types of network services.

In yet another aspect, the technology relates to a method, including receiving, by a computing system and via a UI, a first user input to select a first network service template among a plurality of network service templates, wherein the first user input includes a physical address of a building in which a network service corresponding to the first network service template is to be provided; receiving, by the computing system and via the UI, a second user input to select a first service configuration template from among a plurality of service configuration templates, the first service configuration template corresponding to a service configuration for configuring the network service; autonomously establishing, by the computing system, a network connection between a gateway device located at a customer premises associated with the physical address and a network node that connects to networks of a service provider, based on autonomous configurations that include an exchange of BGP information between the computing system and the gateway device that is used to establish a BGP session; autonomously provisioning, by the computing system, the network service over the network connection, based on the first network service template; and autonomously configuring, by the computing system, the network service based on the first service configuration template.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

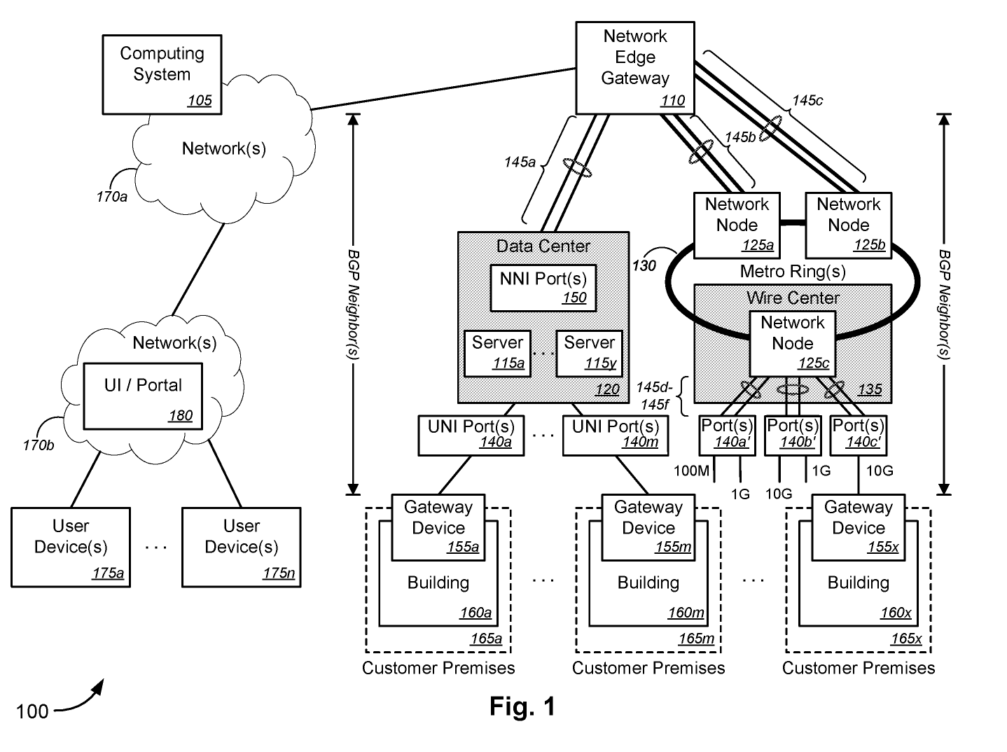

Turning to the embodiments as illustrated by the drawings, FIGS. 1-6 illustrate some of the features of methods, systems, and apparatuses for implementing provisioning of network services, and, more particularly, to methods, systems, and apparatuses for implementing self-service BGP instantiation, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 depicts an example system 100 for implementing self-service BGP instantiation, in accordance with various embodiments.

In examples, system 100 may include a computing system 105, a network edge gateway 110, a plurality of servers 115a-115y (collectively, "servers 115" or the like) disposed at a data center 120, a plurality of network nodes 125a-125c (collectively, "network nodes 125" or the like) that may be connected to a metro ring(s) 130 and/or disposed at a wire center 135, a plurality of UNI ports 140a-140m and/or ports 140a'-140c' (collectively, "ports 140" or the like), a plurality of link aggregation groups ("LAGs") 145a-145f (collectively, "LAGs 145" or the like; each LAG being denoted by parallel lines bundled by a ring shape), and one or more NNI ports 150, and/or the like. System 100 may further include a plurality of gateway devices 155a-155m-155x (collectively, "gateway devices 155" or the like) that is disposed in a corresponding plurality of buildings 160a-160m-160x (collectively, "buildings 160" or the like) that is located at a corresponding plurality of customer premises 165a-165m-165x (collectively, "customer premises 165" or the like). System 100 may further include networks 170a and 170b (collectively, "networks 170" or the like) that are associated with, managed or operated by, and/or owned by a service provider. System 100 may further include a plurality of user devices 175a-175n (collectively, "user devices 175" or the like) that is associated with a corresponding plurality of users or customers, each of whom is associated with, or is an agent or representative of an entity who is associated with, one of the plurality of customer premises 165a-165m-165x. System 100 may further include a UI or portal ("UI/portal") 180. Herein, m, n, x, and y are non-negative integer numbers that may be either all the same as each other, all different from each other, or some combination of same and different (e.g., one set of two or more having the same values with the others having different values, a plurality of sets of two or more having the same value with the others having different values, etc.).

In examples, the computing system 105, which may be disposed within network(s) 170a, may communicatively couple with the network edge gateway 110, which may be disposed in network(s) 170a or in another network. Alternatively, the computing system 105 may include the network edge gateway 110, or the network edge gateway 110 may otherwise be part of the computing system 105. The network edge gateway 110 may communicatively couple with the plurality of servers 115a-115y at the data center 120, via LAG 145a and, in some cases where the network edge gateway 110 and at least one server 115 among the plurality of servers 115a-115y are in different networks, via the one or more NNI ports 150. In some examples, one or more of the plurality of servers 115a-115y may communicatively couple with one or more gateway devices 155a-155m at corresponding buildings 160a-160m, located at customer premises 165a-165m, via corresponding UNI ports 140a-140m.

Alternatively or additionally, in some examples, the network edge gateway 110 may communicatively couple, via one or more LAGs 145b and 145c, with one or more network nodes (in this case, network nodes 125a and 125b, as shown, e.g., in FIG. 1) among the plurality of network nodes 125a-125c, which may be connected to the metro ring(s) 130 and/or disposed at the wire center 135. At least one network node (in this case, network node 125c), among the plurality of network nodes 125a-125c, that is disposed at the wire center 135 may communicatively couple with a group of ports 140a'-140c' via a corresponding group of LAGs 145d-145f among the plurality of LAGs 145a-145f. In some instances, each of the group of ports 140a-140c may be a UNI port(s) (similar to UNI ports 140a-140m), each UNI port(s) 140 (including UNI ports 140a-140m) representing a demarcation point between a service provider network(s) and a user/customer network(s). Each port(s) (or UNI port(s)) 140 may be connected to one or more communications lines that may be configured to transmit data at either the same or different network speeds (e.g., 100M, 1G, 10G, or 100G, or the like). In some instances, a gateway device (in this case, gateway device 155x) may communicatively couple with network node 125c via one of the group of ports 140a'-140c', in this case, port(s) 140c', via a communication line configured to transmit data at 10G (as shown, e.g., in FIG. 1).

In examples, as shown in FIG. 1, the network edge gateway 110 and each of the gateway device 155 (and intermediate servers 115a-115y and/or network nodes 125a-125c) are BGP neighbors. As used herein, a BGP neighbor (also referred to as a "BGP peer") may refer to a network node (e.g., a router, etc.) that shares a common BGP session with another network node, e.g., by exchanging routing information, BGP settings, and/or BGP configurations, etc. In some cases, customer premises 165a-165m-165x may each include, but is not limited to, one of a residential customer premises, a business customer premises, a corporate customer premises, an enterprise customer premises, an education facility customer premises, a medical facility customer premises, or a governmental customer premises, and/or the like. In some instances, customers or users associated with the customer premises 165a-165m-165x, and/or associated with corresponding ones of the gateway devices 155a-155m-155x and/or the buildings 160a-160m-160x, may each include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like. In some instances, each user device 175 may include one of a desktop computer, a laptop computer, a tablet computer, a smart phone, a mobile phone, or any suitable user device, or the like.

According to some embodiments, unless otherwise indicated, networks 170a and 170b may each include, without limitation, one of a local area network ("LAN"), including, without limitation, a fiber network, an Ethernet network, a Token-Ring™ network, and/or the like; a wide-area network ("WAN"); a wireless wide area network ("WWAN"); a virtual network, such as a virtual private network ("VPN"); the Internet; an intranet; an extranet; a public switched telephone network ("PSTN"); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, unless otherwise indicated, the networks 170a and 170b may include an access network of the service provider (e.g., an Internet service provider ("ISP")). In another embodiment, unless otherwise indicated, the networks 170a and 170b may include a core network of the service provider and/or the Internet.

In some aspects, a user device 175, which may be disposed at one of the customer premises 165 or disposed external to any of the customer premises 165a-165m-165x, may send a user input, via UI/portal 180 and via network(s) 170a and/or 170b, to computing system 105, to order a network service from a service provider. In examples, the network service may include an Internet service, a Layer 3 VPN service, a Layer 2 Ethernet service, a Multi-point Layer 2 service, an Ethernet Point-to-Point Products, a network security service, or a DDoS service, and/or the like. In some examples, the user input may include a physical address of a building 160 among the buildings 160a-160m-160x in which the network service is to be provided by the service provider. In some examples, the user input may include a selection of a BGP routing option among a plurality of routing options, which, in some cases, may include one of a static routing option or a dynamic routing option. In some instances, the user input may further include a selection of a BGP creation method among a plurality of BGP creation options, which may include cloning an existing BGP routed service and creating a new BGP routed service. In examples, the user input may further include a selection of an autonomous system number ("ASN") type among a plurality of ASN type options, which may include using a customer's own ASN or using an ASN provided by the service provider. Alternatively or additionally, the user input may include a selection of a fiber type among a plurality of fiber type options, which may include single mode fiber and multimode fiber and/or a selection of a UNI connector type among a plurality of UNI connector type options, which include Lucent Connector ("LC") type and Square Connector ("SC") type.

After receiving the user input, the computing system 105 and/or the network edge gateway 110 may identify a gateway device 155 among the plurality of gateway devices 155a-155m-155x to provide the network service through, in some cases, based on a determination as to which gateway device 155 is located at a customer premises (among the customer premises 165a-165m-165x) and/or a building (among the buildings 160a-160m-160x) that is associated with the physical address indicated in the user input. The computing system 105 and/or the network edge gateway 110 may connect with the identified gateway device 155, and may exchange BGP information (e.g., routing information, BGP settings, and/or BGP configurations, etc.) with the gateway device 155. The computing system 105 and/or the network edge gateway 110 may identify a set of network routes between the gateway device 155 and a network node that connects to networks of the service provider (e.g., the network edge gateway 110, at least one of the plurality of servers 115a-115y, and/or at least one of the plurality of network nodes 125a-125c, and/or the like), and may generate a BGP session based on the set of network routes and based on the BGP information that is exchanged. The computing system 105 and/or the network edge gateway 110 may establish a network connection between the gateway device 155 and the network node, based on the BGP session, and may provision the network service to devices at the customer premises 165 via the gateway device 155.

In the case that the user input includes a selection of a UNI port 140 (e.g., among UNI ports 140a-140m and/or ports 140a'-140c') for the physical address, the customer premises, and/or the building, the set of network routes that may be identified may include routing through the selected UNI port 140 and over a corresponding connection line (e.g., one of 100M, 1G, 10G, or 100G communication lines, or the like). In the case that the user input includes selection of a network service template among a plurality of network service templates, the network service may be provisioned based on the selected network service template. In the case that the user input includes selection of a service configuration template from among a plurality of service configuration templates, the network service may be configured based on the selected service configuration template.

In examples, the computing system 105 and/or the network edge gateway 110 may utilize a site analysis tool to generate a report associated with configurations of the gateway device 155 at the customer premises 165, and may send the report to the user device 175. In some cases, BGP updates may be sent to gateway devices including the gateway device 155 as they are generated or ready to send. In other cases, a number of BGP updates may be held by the computing system 105 and/or the network edge gateway 110 until either a time duration (e.g., 1, 2, 3, 4, 5, 10, 15, 20, 30, 45, 60, 90, 120 minutes, or a range of between 1and 120 minutes, or 1, 2, 3, 4, 5, 6, 10, 12, 15, 18, 20, 24, 36, or 48 hours, or a range of between 1 and 48 hours, or longer) has elapsed or a number BGP update packages have been held that exceed a threshold number (e.g., 10, 12, 20, 25, 30, 40, 50, 75, 100, 150, or 200 packages, or a range of 10-200 packages, or more). After one of the time duration has elapsed or the number of held BGP update packages has exceeded the threshold number, the computing system 105 and/or the network edge gateway 110 may deploy the held BGP update packages to their corresponding destinations, which includes the gateway device 155. The BGP update packages may be used to update a corresponding one of a plurality of BGP sessions (such as the BGP session for the gateway device 155). In the case that the user input includes a request to end or terminate the network service, the computing system 105 and/or the network edge gateway 110 may terminate the network service, in some cases, using an NNI.

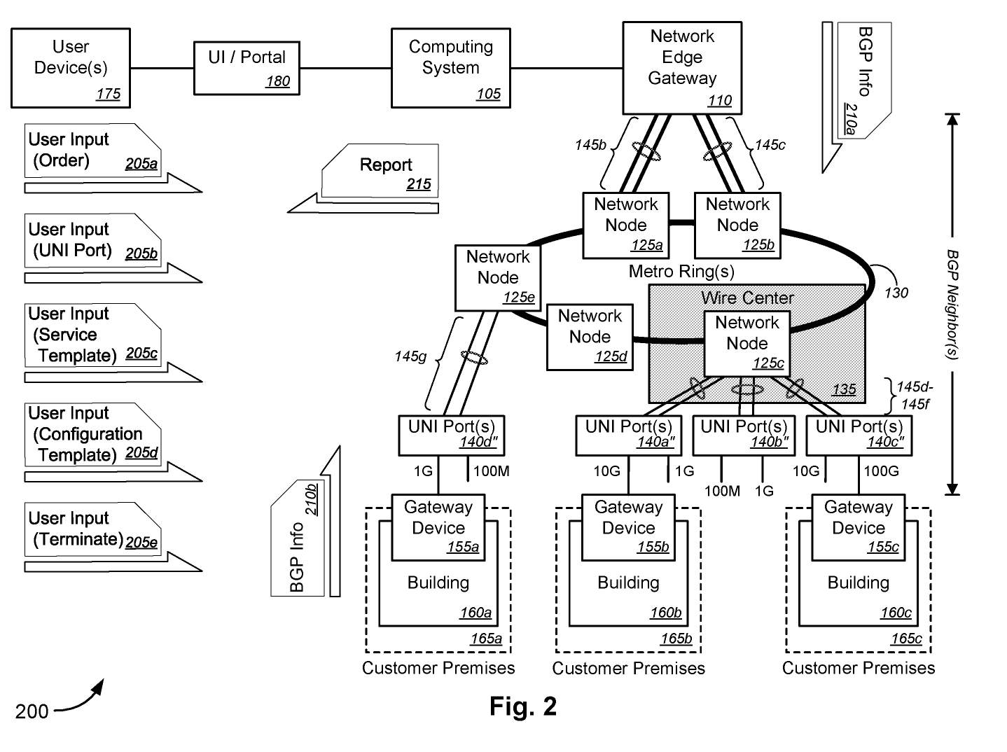

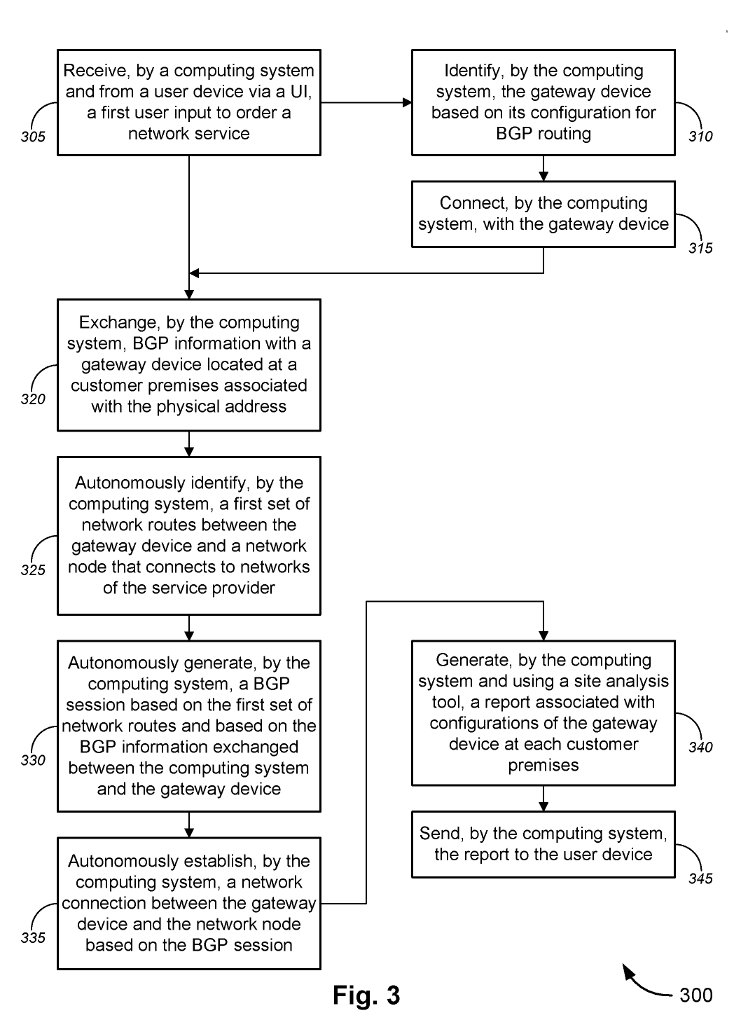

These and other functionalities of the system 100 particularly with respect to establishing a network connection (e.g., based on a BGP session) between a gateway device (e.g., one of gateway devices 155a-155m-155x) and a network node (e.g., network edge gateway 110, one of servers 115a-115y, or one of network nodes 125a-125c, etc.) are described in detail below with respect to FIGS. 2-5. In operation, the computing system 105 and/or the network edge gateway 110 may perform methods for implementing self-service BGP instantiation, as described in detail with respect to FIGS. 2-5. For example, communication exchanges as described below with respect to FIG. 2, example methods 300, 400, and 500 as described below with respect to FIGS. 3, 4, and 5, respectively, may be applied with respect to the operations of system 100 of FIG. 1.

FIG. 2 depicts an example system 200 illustrating communication exchange between a computing system(s) and gateway devices at customer premises when implementing self-service BGP instantiation, in accordance with various embodiments. In some embodiments, computing system 105, network edge gateway 110, network nodes 125a-125e, metro ring(s) 130, wire center 135, UNI ports 140a"-140d", LAGs 145b-145g, gateway devices 155a-155c, buildings 160a-160c, customer premises 165a-165c, user device(s) 175, and UI/portal 180 of FIG. 2 may be similar, if not identical, to the computing system 105, network edge gateway 110, network nodes 125a-125c, metro ring(s) 130, wire center 135, UNI ports 140a-140m and/or ports 140a'-140c', LAGs 145a-145f, gateway devices 155a-155m-155x, buildings 160a-160m-160x, customer premises 165a-165m-165x, user devices 175a-175n, and UI/portal 180 , respectively, of system 100 of FIG. 1, and the description of these components of system 100 of FIG. 1 are similarly applicable to the corresponding components of FIG. 2.

With reference to FIG. 2, example system 200 may include computing system 105 that communicatively couples with user device(s) 175 via UI/portal 180, and that also communicatively couples with network edge gateway 110. As described above with respect to FIG. 1, computing system 105 and network edge gateway 110 either may be separate devices in the same network, may be separate devices in different networks, may be one device that is included in the other device, or may be one device that is a part of the other device. Similar to the configuration in system 100 of FIG. 1, in system 200, the network edge gateway 110 may communicatively couple, via one or more LAGs 145b and 145c, with one or more network nodes (in this case, network nodes 125a and 125b, as shown, e.g., in FIG. 2) among the plurality of network nodes 125a-125e, which may be connected to the metro ring(s) 130 and/or disposed at the wire center 135. At least one network node (in this case, network node 125c), among the plurality of network nodes 125a-125e, that is disposed at the wire center 135 may communicatively couple with a group of UNI ports 140a"-140c" via a corresponding group of LAGs 145d-145f among the plurality of LAGs 145b-145g. Each UNI port(s) 140 among UNI ports 140a"-140c" may be connected to one or more communications lines that may be configured to transmit data at either the same or different network speeds (e.g., 100M, 1G, 10G, 100G, or the like). In an example, a gateway device (in this case, gateway device 155b) may communicatively couple with network node 125c via one of the group of UNI ports 140a"-140c" (in this case, UNI port(s) 140a"), via a corresponding one of LAGs 145d-145f (in this case, LAG 145d), and via a communication line configured to transmit data at 10G (as shown, e.g., in FIG. 2). In another example, another gateway device (in this case, gateway device 155c) may communicatively couple with network node 125c via one of the group of UNI ports 140a"-140c" (in this case, UNI port(s) 140c"), via a corresponding one of LAGs 145d-145f (in this case, LAG 145f), and via a communication line configured to transmit data at 100G (as shown, e.g., in FIG. 2). In yet another example, network node 125e, which is external to the wire center 135 yet part communicatively coupled to the metro ring(s) 130, may communicatively couple with UNI port(s) 140d" via LAG 145g, while gateway device 155a may communicatively couple with network node 125e via UNI port(s) 140d", via LAG 145g, and via a communication line configured to transmit data at 1G (as shown, e.g., in FIG. 2). In examples, as shown in FIG. 1, the network edge gateway 110 and each of the gateway device 155 (and intermediate network nodes 125a-125e) are BGP neighbors.

In operation, the user device(s) 175 may send a user input (e.g., one or more of user inputs 205a-205e, or the like) to computing system 105 via UI/portal 180. In examples, the user inputs 205a-205e may include a user input 205a to order a network service, a user input 205b to select one or more UNI ports over which to establish a BGP session/connection, a user input 205c to select a network service template among a plurality of network service templates, a user input 205d to select a service configuration template from among a plurality of service configuration templates, and/or a user input 205e to end or terminate a network service among the one or more network services, and/or the like. The network service template may correspond to a service template that may be used to provision the network service. The service configuration template may correspond to a service configuration for configuring the network service that is provisioned, and may include small, medium, and/or large configuration profiles or standards.

After receiving the user input, the computing system 105 and/or the network edge gateway 110 may identify at least one gateway device 155 among the plurality of gateway devices 155a-155c to provide the network service through, in some cases, based on a determination as to which gateway device 155 is located at a customer premises (among the customer premises 165a-165m-165x) and/or a building (among the buildings 160a-160m-160x) that is associated with the physical address indicated in the user input. In some examples, one customer premises may be provisioned for a requesting entity. In the case that the requesting entity has multiple customer premises and intends to provision network services at the multiple customer premises, which may be separated across different (in some cases, distant) geographic locations (e.g., locations in different cities, different states, different provinces, or different regions/territories of a nation, or across international borders and territories, etc.), the user input may include a listing of what network services to provide at which customer premises. The computing system 105 and/or the network edge gateway 110 may connect with the identified gateway device 155, and may exchange BGP information 210a and 210b with the gateway device 155. In some examples, the BGP information 210a and 210b that may be exchanged may include routing information, BGP settings, and/or BGP configurations, and/or the like. The computing system 105 and/or the network edge gateway 110 may identify a set of network routes between each of the at least one gateway device 155 and a corresponding network node that connects to networks of the service provider (e.g., the network edge gateway 110 and/or at least one of the plurality of network nodes 125a-125e, and/or the like), and may generate a BGP session for each of the at least one gateway device 155, based on the set of network routes and based on the BGP information 210a and 210b that is exchanged. The computing system 105 and/or the network edge gateway 110 may establish a network connection between the at least one gateway device 155 and the corresponding network node, based on the BGP session, and, for each of the at least one gateway device 155, may provision the corresponding network service to devices at the corresponding customer premises 165 via that gateway device 155.

In the case that the user input includes a selection of a UNI port 140 (e.g., among UNI ports 140a-140m and/or ports 140a'-140c') for each physical address, each customer premises, and/or each building, the set of network routes that may be identified may include routing through the selected UNI port 140 and over a corresponding connection line (e.g., one of 100M, 1G, 10G, or 100G communication lines, or the like). In the case that the user input includes selection of a network service template among a plurality of network service templates, the network service may be provisioned based on the selected network service template. In the case that the user input includes selection of a service configuration template from among a plurality of service configuration templates, the network service may be configured based on the selected service configuration template.

In examples, the computing system 105 and/or the network edge gateway 110 may utilize a site analysis tool to generate a report 215 associated with configurations of each of the at least one gateway device 155 at the corresponding customer premises 165, and may send the report 215 to the user device 175. In some examples, the report 215 may also indicate at least one of whether the network service has been successfully provisioned, which UNI port(s) 140 and/or which connection line (e.g., among 100M, 1G, 10G, or 100G communication lines, or the like) was used to establish the network connection with each of the at least one gateway device 155, and/or the like. In some cases, BGP updates may be sent to gateway devices including the gateway device 155 as they are generated or ready to send. In other cases, a number of BGP updates may be held by the computing system 105 and/or the network edge gateway 110 until either a time duration (e.g., 1, 2, 3, 4, 5, 10, 15, 20, 30, 45, 60, 90, 120 minutes, or a range of between 1 and 120 minutes, or 1, 2, 3, 4, 5, 6, 10, 12, 15, 18, 20, 24, 36, or 48 hours, or a range of between 1 and 48 hours, or longer) has elapsed or a number BGP update packages have been held that exceed a threshold number (e.g., 10, 12, 20, 25, 30, 40, 50, 75, 100, 150, or 200 packages, or a range of 10-200 packages, or more). After one of the time duration has elapsed or the number of held BGP update packages has exceeded the threshold number, the computing system 105 and/or the network edge gateway 110 may deploy the held BGP update packages to their corresponding destinations in a batch in an asynchronous manner, which includes each of the at least one gateway device 155. The BGP update packages may be used to update a corresponding one of a plurality of BGP sessions (such as the BGP session for the gateway device 155). In the case that the user input includes a request to end or terminate the network service at one or more customer premises, the computing system 105 and/or the network edge gateway 110 may terminate the identified network service at the identified customer premises, in some cases, using an NNI. In some instances, a report 215 may be sent indicating that the network service has been terminated.

In the manner described above with respect to FIGS. 1 and 2, the system, via the UI/portal 180, enables a user to provision and terminate network services over BGP sessions, in a self-service manner, via one or both of NNIs and UNIs, rather than the service provider having to set up provisioning and termination at data centers. Herein with respect to FIGS. 1-5, where one of NNI or UNI is described as used for performing a task or operation, the other of the NNI or UNI may also be used. Different from conventional systems and implementations in which BGP connectivity is either in cloud networks or at the data center level, the present technology provides full BGP-based connectivity from cloud networks and/or data center networks down to user/customer networks at the customer premises level (at particular buildings, as specified by physical addresses in the user input/order). The present technology also enables BGP settings and configurations on-demand, via the UI/portal 180.

FIG. 3 depicts a flow diagram illustrating a method 300 for implementing self-service BGP instantiation, in accordance with various embodiments. With reference to FIG. 3, the operations of example method 300 may be performed by a computing system(s) (e.g., computing system(s) 105 of FIGS. 1 and 2, which, in some cases, may include network edge gateway 110 of FIGS. 1 and 2, or the like).

In the example method 300 of FIG. 3, at operation 305, a computing system, which may be located within a network (e.g., network(s) 170a of FIG. 1, or the like) of a service provider, may receive a first user input to order a network service (e.g., user input 205a of FIG. 2, or the like) from a user device (e.g., one of user devices 175a-175n or 175 of FIGS. 1 and 2, or the like) via a UI (e.g., UI/portal 180 of FIGS. 1 and 2, or the like). In some examples, the first user input may include a physical address of a building (e.g., one of buildings 160a-160m-160x and 160a-160c of FIGS. 1 and 2, or the like) in which the network service is to be provided by the service provider. In some examples, the first user input may include a selection of a BGP routing option among a plurality of routing options. In some cases, the plurality of routing options may further include a static routing option. In some instances, the first user input may further include a selection of a BGP creation method among a plurality of BGP creation options, where the plurality of BGP creation options may include cloning an existing BGP routed service and creating a new BGP routed service. In examples, the first user input may further include a selection of an ASN type among a plurality of ASN type options, where the plurality of ASN type options may include using a customer's own ASN or using an ASN provided by the service provider. Alternatively or additionally, the first user input may include a selection of a fiber type among a plurality of fiber type options and a selection of a UNI connector type among a plurality of UNI connector type options. In some instances, the plurality of fiber type options may include single mode fiber and multimode fiber. In some cases, the plurality of UNI connector type options may include LC type and SC type. Method 300 may either continue onto the process at operation 310 or continue onto the process at operation 320.

In examples, the gateway device may be configured for BGP routing based on one of pre-configuration by the service provider, configuration by a customer at the customer premises, or configuration by a technician, or the like. At operation 310, the computing system may identify the gateway device based on its configuration for BGP routing, and may connect with a gateway device (e.g., a corresponding one of gateway devices 155a-155m-155x and 155a-155c of FIGS. 1 and 2, or the like) located at a customer premises associated with the physical address (e.g., a corresponding customer premises 165a-165m-165x and 165a-165c of FIGS. 1 and 2, or the like) (at operation 315). Method 300 may continue onto the process at operation 320.

At operation 320, the computing system may exchange BGP information (e.g., BGP information 210a and 210b of FIG. 2, or the like) with the gateway device. At operation 325, the computing system may autonomously identify a first set of network routes between the gateway device and a network node (e.g., servers 115a-115y or network nodes 125a-125c of FIG. 1 or network nodes 125a-125e of FIG. 2, or the like) that connects to networks of the service provider, in some cases, by analyzing available network routes between the gateway device and the network node. At operation 330, the computing system may autonomously generate a BGP session based on the first set of network routes and based on the BGP information exchanged between the computing system and the gateway device. In examples, the BGP session may be a one-time peering session, and the network connection and subsequent network connections between the gateway device and the network node may be based on the one-time peering session. At operation 335, the computing system may autonomously establish a network connection between the gateway device and the network node based on the BGP session.

In some examples, the first user input may include a plurality of physical addresses of a plurality of buildings in which the network service is to be provided by the service provider. In such examples, exchanging the BGP information, identifying the first set of network routes, generating the BGP session, and establishing the network connection (at operations 320-335) may include, for each customer premises corresponding to one of the plurality of buildings: (a) the computing system exchanging BGP information with a gateway device located at that customer premises associated with one of the plurality of physical addresses; (b) the computing system autonomously identifying a set of network routes between that gateway device and a closest network node that connects to networks of the service provider, by, in some cases, analyzing available network routes between that gateway device and the closest network node; (c) the computing system autonomously generating a BGP session based on the set of network routes; and (d) the computing system autonomously establishing a network connection between that gateway device and the closest network node based on the BGP session. At operation 340, the computing system may generate, using a site analysis tool, a report (e.g., report 215 of FIG. 2, or the like) associated with configurations of the gateway device at each customer premises, and may send the report to the user device (at operation 345).

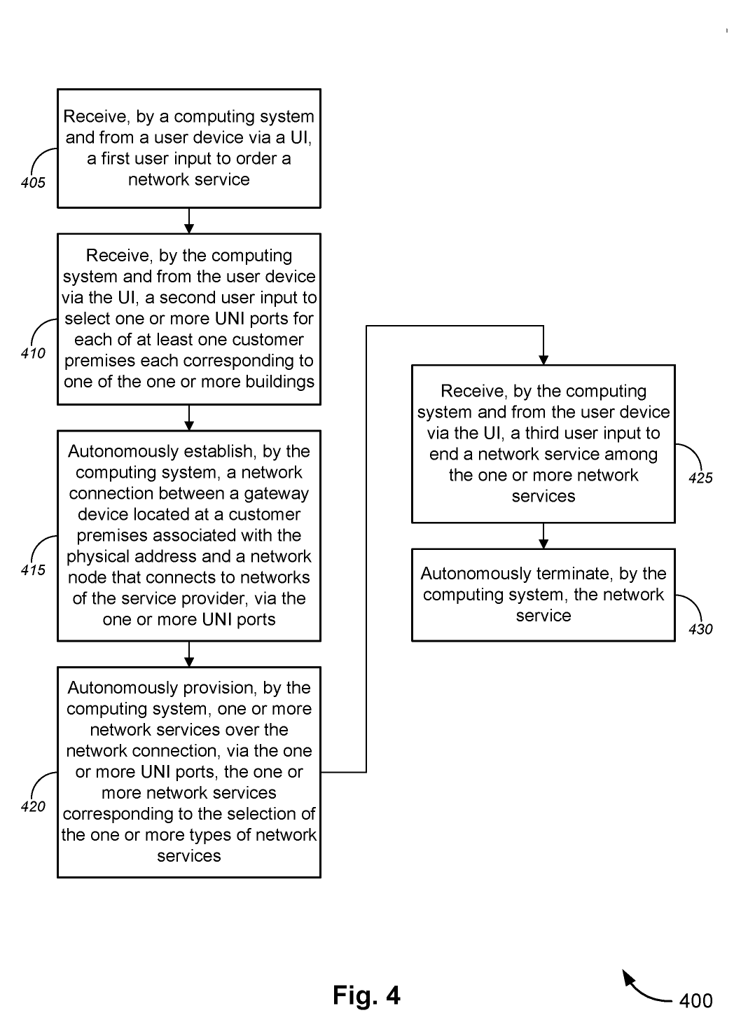

FIG. 4 depicts a flow diagram illustrating another method 400 for implementing self-service BGP instantiation, in accordance with various embodiments. Referring to FIG. 4, the operations of example method 400 may be performed by a computing system(s) (e.g., computing system(s) 105 of FIGS. 1 and 2, which, in some cases, may include network edge gateway 110 of FIGS. 1 and 2, or the like).

In the example method 400 of FIG. 4, at operation 405, a computing system, which may be located within a network (e.g., network(s) 170a of FIG. 1, or the like) of a service provider, may receive a first user input (e.g., user input 205a of FIG. 2, or the like) to order a network service from a user device (e.g., one of user devices 175a-175n or 175 of FIGS. 1 and 2, or the like) via a UI (e.g., UI/portal 180 of FIGS. 1 and 2, or the like). In some examples, the first user input may include a physical address of each of one or more buildings (e.g., among buildings 160a-160c of FIG. 2, or the like) in which the network service is to be provided by the service provider. In some cases, the first user input may further include a selection of one or more types of network services.

At operation 410, the computing system may receive, from the user device via the UI, a second user input (e.g., user input 205b of FIG. 2, or the like) to select one or more UNI ports (e.g., among UNI ports 140a-140d of FIG. 2, or the like) for each of at least one customer premises (e.g., corresponding customer premises among customer premises 165a-165c of FIG. 2, or the like) each corresponding to one of the one or more buildings. At operation 415, the computing system may autonomously establish a network connection between a gateway device (e.g., a corresponding one of gateway devices 155a-155c of FIG. 2, or the like) located at a customer premises associated with the physical address (e.g., a corresponding one of customer premises 165a-165c of FIG. 2, or the like) and a network node (e.g., among network nodes 125a-125e of FIG. 2, or the like) that connects to networks of the service provider, via the one or more UNI ports. In some examples, autonomously establishing the network connection between the gateway device and the network node (at operation 415) may be based on autonomous configurations that include an exchange of BGP information (e.g., BGP information 210a and 210b of FIG. 2, or the like) between the computing system and the gateway device that is used to establish a BGP session. In examples, the autonomous configurations may be based on a selection, by a user associated with the user device, of a routing technology among a plurality of routing technologies, where the plurality of routing technologies may further include a static routing service, and where the routing technology selected by the user may be a BGP-based routing service. In some cases, the network connection may be configured to establish connectivity between the network node and the gateway device via at least one of a newly established connection via the one or more UNI ports, an existing UNI port, or a NNI port.

At operation 420, the computing system may autonomously provision one or more network services over the network connection, via the one or more UNI ports, the one or more network services corresponding to the selection of the one or more types of network services. In some examples, the one or more types of network service may include at least one of Internet service, Layer 3 VPN service, Layer 2 Ethernet service, Multi-point Layer 2 service, Ethernet Point-to-Point Products, network security service, or DDoS service, and/or the like.

Method 400 may further include the computing system receiving a third user input (e.g., user input 205e of FIG. 2, or the like) to end a network service among the one or more network services, from the user device via the UI (at operation 425), and autonomously terminating the network service, in response to receiving the third user input (at operation 430). In some instances, the network service utilizes network resources provided by one or more sources of network resources, the network service including a previously provisioned Internet service, Layer 3 VPN service, Layer 2 Ethernet service, Multi-point Layer 2 service, Ethernet Point-to-Point Products, network security service, or DDoS service, and/or the like. In examples, autonomously terminating the network service, may include removing configurations for the network service being terminated; returning the network resources utilized by the network service being terminated to the one or more sources of network resources; and terminating billing for the network resources being terminated.

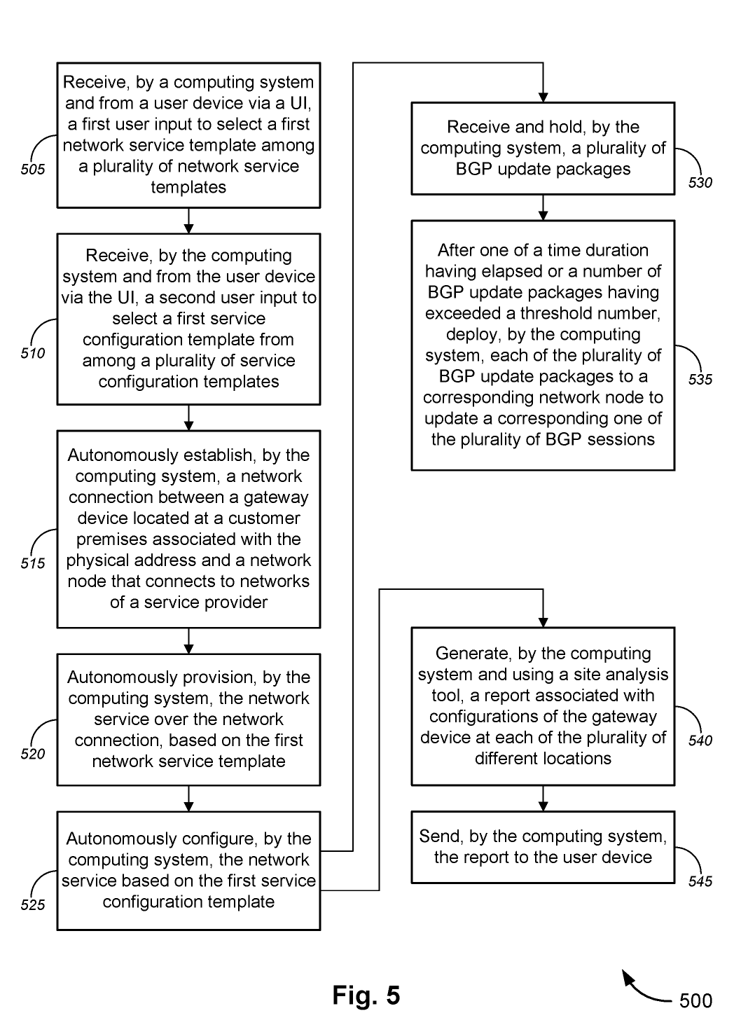

FIG. 5 depicts a flow diagram illustrating yet another method 500 for implementing self-service BGP instantiation, in accordance with various embodiments. With reference to FIG. 5, the operations of example method 500 may be performed by a computing system(s) (e.g., computing system(s) 105 of FIGS. 1 and 2, which, in some cases, may include network edge gateway 110 of FIGS. 1 and 2, or the like).

In the example method 500 of FIG. 5, at operation 505, a computing system, which may be located within a network (e.g., network(s) 170a of FIG. 1, or the like) of a service provider, may receive a first user input (e.g., user input 205c of FIG. 2, or the like) to select a first network service template among a plurality of network service templates, from a user device (e.g., one of user devices 175a-175n or 175 of FIGS. 1 and 2, or the like) via a UI (e.g., UI/portal 180 of FIGS. 1 and 2, or the like). In some examples, the first user input may include a physical address of a building (e.g., one of buildings 160a-160m-160x and 160a-160c of FIGS. 1 and 2, or the like) in which a network service corresponding to the first network service template is to be provided.

At operation 510, the computing system may receive, from the user device via the UI, a second user input (e.g., user input 205d of FIG. 2, or the like) to select a first service configuration template from among a plurality of service configuration templates, the first service configuration template corresponding to a service configuration for configuring the network service. At operation 515, the computing system may autonomously establish a network connection between a gateway device (e.g., a corresponding one of gateway devices 155a-155m-155x and 155a-155c of FIGS. 1 and 2, or the like) located at a customer premises associated with the physical address (e.g., a corresponding customer premises 165a-165m-165x and 165a-165c of FIGS. 1 and 2, or the like) and a network node (e.g., servers 115a-115y or network nodes 125a-125c of FIG. 1 or network nodes 125a-125e of FIG. 2, or the like) that connects to networks of the service provider. In examples, autonomously establishing the network connection between the gateway device and the network node (at operation 515) may be based on autonomous configurations that include an exchange of BGP information (e.g., BGP information 210a and 210b of FIG. 2, or the like) between the computing system and the gateway device that may be used to establish a BGP session.

At operation 520, the computing system may autonomously provision the network service over the network connection, in some cases, based on the first network service template. The computing system may autonomously configure the network service based on the first service configuration template (at operation 525). Method 500 may either continue onto the process at operation 530 or continue onto the process at operation 540.

In examples, the first user input may include a selection of a single network service template corresponding to a same network service for provisioning at each of a plurality of different locations. In some cases, the first user input may further include a physical address of each building among one or more buildings in which the same network service is to be provided. In some instances, the second user input may include a selection of a single service configuration template corresponding to a same service configuration for configuring the same network service at each of the plurality of different locations. In some examples, autonomously establishing the network connection, autonomously provisioning the network service, and autonomously configuring the network service (at operations 515-525) may be autonomously replicated for each of the plurality of different locations, in some cases, by replicating autonomous provisioning of the same network service and autonomous configuration of the same network service using the same service configuration for each of the plurality of different locations. In examples, the computing system may receive and hold a plurality of BGP update packages (at operation 530). In some instances, each BGP update package may correspond to one of a plurality of BGP sessions that is used to establish a network connection between a gateway device at each of the plurality of different locations and a corresponding closest network node. At operation 535, after one of a time duration (e.g., 1, 2, 3, 4, 5, 10, 15, 20, 30, 45, 60, 90, 120 minutes, or a range of between 1 and 120 minutes, or 1, 2, 3, 4, 5, 6, 10, 12, 15, 18, 20, 24, 36, or 48 hours, or a range of between 1 and 48 hours, or longer) having elapsed or a number of BGP update packages having exceeded a threshold number (e.g., 10, 12, 20, 25, 30, 40, 50, 75, 100, 150, or 200 packages, or a range of 10-200 packages, or more), the computing system may deploy each of the plurality of BGP update packages to a corresponding network node to update a corresponding one of the plurality of BGP sessions. In some cases, the plurality of BGP update packages may be deployed sequentially, concurrently, or in concurrent sequences.

Alternatively or additionally, in some examples, the computing system may generate, using a site analysis tool, a report (e.g., report 215 of FIG. 2, or the like) associated with configurations of the gateway device at each of the plurality of different locations (at operation 540), and may send the report to the user device (at operation 545). In some examples, the report may include similarities and differences in the configurations of the gateway devices at the plurality of different locations.

While the techniques and procedures in methods 300, 400, and 500 are depicted and/or described in a certain order for purposes of illustration, it should be appreciated that certain procedures may be reordered and/or omitted within the scope of various embodiments. Moreover, while the methods 300, 400, and 500 may be implemented by or with (and, in some cases, are described below with respect to) the systems, examples, or embodiments 100 and 200 of FIGS. 1 and 2, respectively (or components thereof), such methods may also be implemented using any suitable hardware (or software) implementation. Similarly, while each of the systems, examples, or embodiments 100 and 200 of FIGS. 1 and 2, respectively (or components thereof), can operate according to the methods 300, 400, and 500 (e.g., by executing instructions embodied on a computer readable medium), the systems, examples, or embodiments 100 and 200 of FIGS. 1 and 2 can each also operate according to other modes of operation and/or perform other suitable procedures.

### Exemplary System and Hardware Implementation

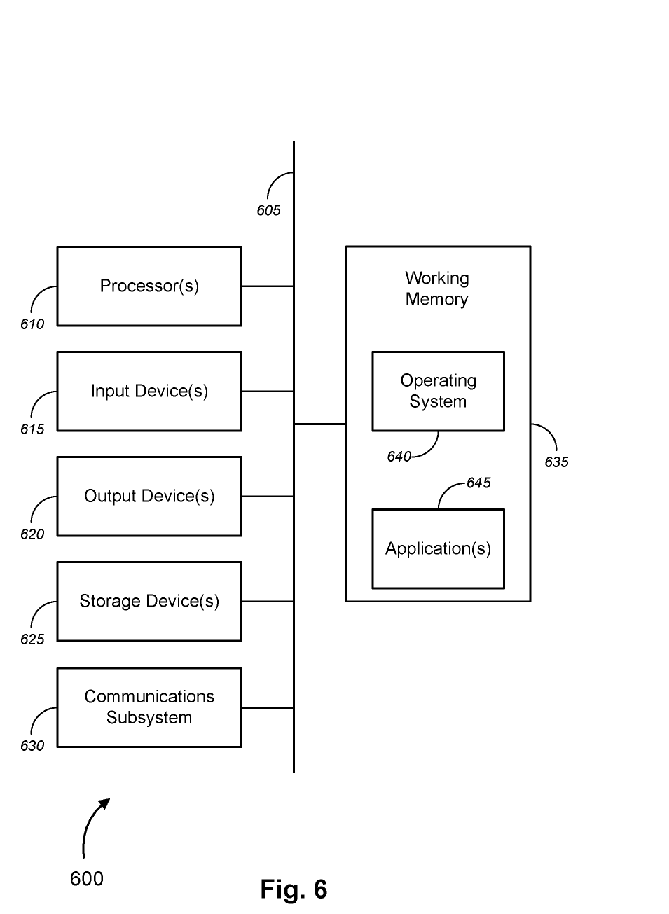

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., computing system(s) 105, network edge gateway(s) 110, servers 115a-115y, network nodes 125a-125e, metro ring(s) 130, UNI ports 140a-140m and 140a"-140d" and/or ports 140a'-140c', NNI port(s) 150, gateway devices 155a-155m-155x, 155a, 155b, and 155c, user devices 175a-175n, and UI(s)/portal(s) 180, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600 – which might represent an embodiment of the computer or hardware system (i.e., computing system(s) 105, network edge gateway(s) 110, servers 115a-115y, network nodes 125a-125e, metro ring(s) 130, UNI ports 140a-140m and 140a"-140d" and/or ports 140a'-140c', NNI port(s) 150, gateway devices 155a-155m-155x, 155a, 155b, and 155c, user devices 175a-175n, and UI(s)/portal(s) 180, etc.), described above with respect to FIGS. 1-5 – is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can include, without limitation, local and/or network accessible storage, and/or can include, without limitation, a disk drive, a drive array, an optical storage device, solid-state storage device such as a random access memory ("RAM") and/or a read-only memory ("ROM"), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network ("WWAN") device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further include a working memory 635, which can include a RAM or ROM device, as described above.

The computer or hardware system 600 also may include software elements, shown as being currently located within the working memory 635, including an operating system 640, device drivers, executable libraries, and/or other code, such as one or more application programs 645, which may include computer programs provided by various embodiments (including, without limitation, hypervisors, virtual machines ("VMs"), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms "machine readable medium" and "computer readable medium," as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire, and fiber optics, including the wires that include the bus 605, as well as the various components of the communication subsystem 630 (and/or the media by which the communications subsystem 630 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system and via a user interface ("UI"), a first user input to order a network service, wherein the first user input includes a physical address of a building in which network service is to be provided by a service provider;
exchanging, by the computing system, border gateway protocol ("BGP") information with a gateway device located at a customer premises associated with the physical address;
autonomously identifying, by the computing system, a first set of network routes between the gateway device and a network node that connects to networks of the service provider, by analyzing available network routes between the gateway device and the network node;
autonomously generating, by the computing system, a BGP session based on the first set of network routes and based on the BGP information exchanged between the computing system and the gateway device; and
autonomously establishing, by the computing system, a network connection between the gateway device and the network node based on the BGP session.

2. The method of claim 1,
wherein the first user input includes a plurality of physical addresses of a plurality of buildings in which the network service is to be provided by the service provider;
wherein exchanging the BGP information, identifying the first set of network routes, generating the BGP session, and establishing the network connection comprise, for each customer premises corresponding to one of the plurality of buildings:
exchanging, by the computing system, BGP information with a gateway device located at that customer premises associated with one of the plurality of physical addresses;
autonomously identifying, by the computing system, a set of network routes between that gateway device and a closest network node that connects to networks of the service provider, by analyzing available network routes between that gateway device and the closest network node;
autonomously generating, by the computing system, a BGP session based on the set of network routes; and
autonomously establishing, by the computing system, a network connection between that gateway device and the closest network node based on the BGP session.

3. The method of claim 2, further comprising:
generating, by the computing system and using a site analysis tool, a report associated with configurations of the gateway device at each customer premises; and
sending, by the computing system, the report to a user device.

4. The method of claim 1, wherein the BGP session is a one-time peering session, and wherein the network connection and subsequent network connections between the gateway device and the network node are based on the one-time peering session.

5. The method of claim 1, wherein the first user input includes a selection of a BGP routing option among a plurality of routing options, wherein the plurality of routing options further includes a static routing option, wherein the first user input further includes a selection of a BGP creation method among a plurality of BGP creation options, wherein the plurality of BGP creation options includes cloning an existing BGP routed service and creating a new BGP routed service.

6. The method of claim 5, wherein the first user input further includes a selection of an autonomous system number ("ASN") type among a plurality of ASN type options, wherein the plurality of ASN type options includes using a customer's own ASN or using an ASN provided by the service provider.

7. The method of claim 1, wherein the first user input includes a selection of a fiber type among a plurality of fiber type options and a selection of a user-network interface ("UNI") connector type among a plurality of UNI connector type options.

8. The method of claim 1, wherein the gateway device is configured for BGP routing based on one of pre-configuration by the service provider, configuration by a customer at the customer premises, or configuration by a technician, wherein the method further comprises, prior to exchanging the BGP information:
identifying, by the computing system, the gateway device based on its configuration for BGP routing; and
connecting, by the computing system, with the gateway device.

9. The method of claim 1, wherein the network service includes at least one of an Internet service, a Layer 3 VPN service, a Layer 2 Ethernet service, a Multi-point Layer 2 service, an Ethernet Point-to-Point Products, a network security service, or a DDoS service.

10. A method, comprising:
receiving, by a computing system and via a user interface ("UI"), a first user input to order a network service, wherein the first user input includes a physical address of each of one or more buildings in which network service is to be provided by a service provider, wherein the first user input further includes a selection of one or more types of network services;
receiving, by the computing system and via the UI, a second user input to select one or more user-network interface ("UNI") ports for each of at least one customer premises each corresponding to one of the one or more buildings;
autonomously establishing, by the computing system, a network connection between a gateway device located at a customer premises associated with the physical address and a network node that connects to networks of the service provider, via the one or more UNI ports, based on autonomous configurations that include an exchange of border gateway protocol ("BGP") information between the computing system and the gateway device that is used to establish a BGP session; and
autonomously provisioning, by the computing system, one or more network services over the network connection, via the one or more UNI ports, the one or more network services corresponding to the selection of the one or more types of network services.

11. The method of claim 10, wherein the autonomous configurations are based on a selection, by a user, of a routing technology among a plurality of routing technologies, wherein the plurality of routing technologies further includes a static routing service, wherein the routing technology selected by the user is a BGP-based routing service.

12. The method of claim 10, wherein the network connection is configured to establish connectivity between the network node and the gateway device via at least one of a newly established connection via the one or more UNI ports, an existing UNI port, or a network-to-network interface ("NNI") port.

13. The method of claim 10, wherein the one or more types of network service include at least one of Internet service, Layer 3 VPN service, Layer 2 Ethernet service, Multi-point Layer 2 service, Ethernet Point-to-Point Products, network security service, or DDoS service.

14. The method of claim 10, further comprising:
receiving, by the computing system and via the UI, a third user input to end a network service among the one or more network services; and
autonomously terminating, by the computing system, the network service.

15. The method of claim 14, wherein the network service utilizes network resources provided by one or more sources of network resources, wherein autonomously terminating the network service comprises:
removing configurations for the network service being terminated;
returning the network resources utilized by the network service being terminated to the one or more sources of network resources; and
terminating billing for the network resources being terminated.

16. A method, comprising:
receiving, by a computing system and via a user interface ("UI"), a first user input to select a first network service template among a plurality of network service templates, wherein the first user input includes a physical address of a building in which a network service corresponding to the first network service template is to be provided;
receiving, by the computing system and via the UI, a second user input to select a first service configuration template from among a plurality of service configuration templates, the first service configuration template corresponding to a service configuration for configuring the network service;
autonomously establishing, by the computing system, a network connection between a gateway device located at a customer premises associated with the physical address and a network node that connects to networks of a service provider, based on autonomous configurations that include an exchange of border gateway protocol ("BGP") information between the computing system and the gateway device that is used to establish a BGP session;
autonomously provisioning, by the computing system, the network service over the network connection, based on the first network service template; and
autonomously configuring, by the computing system, the network service based on the first service configuration template.

17. The method of claim 16,
wherein the first user input includes a selection of a single network service template corresponding to a same network service for provisioning at each of a plurality of different locations;
wherein the first user input further includes a physical address of each building among one or more buildings in which the same network service is to be provided;
wherein the second user input includes a selection of a single service configuration template corresponding to a same service configuration for configuring the same network service at each of the plurality of different locations; and
wherein autonomously establishing the network connection, autonomously provisioning the network service, and autonomously configuring the network service are autonomously replicated for each of the plurality of different locations, by replicating autonomous provisioning of the same network service and autonomous configuration of the same network service using the same service configuration for each of the plurality of different locations.

18. The method of claim 17, further comprising:
receiving and holding, by the computing system, a plurality of BGP update packages, each BGP update package corresponding to one of a plurality of BGP sessions that is used to establish a network connection between a gateway device at each of the plurality of different locations and a corresponding closest network node; and
after one of a time duration having elapsed or a number of BGP update packages having exceeded a threshold number, deploying, by the computing system, each of the plurality of BGP update packages to a corresponding network node to update a corresponding one of the plurality of BGP sessions.

19. The method of claim 17, further comprising:
generating, by the computing system and using a site analysis tool, a report associated with configurations of the gateway device at each of the plurality of different locations; and
sending, by the computing system, the report to a user device,
wherein the report includes similarities and differences in the configurations of the gateway devices at the plurality of different locations.

20. The method of claim 17, wherein the network service includes at least one of an Internet service, a Layer 3 VPN service, a Layer 2 Ethernet service, a Multi-point Layer 2 service, an Ethernet Point-to-Point Products, a network security service, or a DDoS service.
